(19) United States
(12) Patent Application Publication
(10) Pub. No.: US 2009/0122428 A1
(43) Pub. Date: May 14, 2009

(54) Reflective optical elements exhibiting multimetallic-like self-correction of distortions caused by heating

(75) Inventors: Alton H. Phillips, East Palo Alto, CA (US); Douglas C. Watson, Campbell, CA (US)

Correspondence Address: KLARQUIST SPARKMAN, LLP, 121 SW SALMON STREET, SUITE 1600, PORTLAND, OR, 97204, US

(73) Assignee: Nikon Corporation

(21) Appl. No.: 11/983,611

(22) Filed: Nov. 9, 2007

(51) Int. Cl. G02B 7/185

(52) U.S. Cl. 359/846

(57) ABSTRACT

Optical elements are disclosed that exhibit “multimetallic”-like self corrections of thermally induced distortions. An exemplary optical element includes first and second portions. The first portion has a first coefficient of thermal expansion (CTE), an obverse surface, and a reverse surface. A second portion is bonded to the reverse surface. The second portion has a second CTE different from the first CTE to form an optical element exhibiting a thermally multimetallic-like change in curvature of the obverse surface accompanying a temperature change of the optical element. The second portion has a thermal-response property in a first direction that is different from a thermal-response property in a second direction. Thus, aberrations such as astigma-type aberrations can be readily self-corrected.

### FIELD

This disclosure pertains to, inter alia, reflective optical elements such as mirrors. More specifically, the disclosure pertains to cooling or otherwise regulating the temperature of reflective optical elements that, for example, experience heating when irradiated or undergo a temperature change during use.

### BACKGROUND

In various types of optical systems, the constituent optical elements such as lenses, filters, and/or mirrors are impinged with the radiation with which the system is used. If an optical element absorbs some of the incident radiation and especially if the incident radiation is intense, the element likely will experience a significant increase in temperature. Such a temperature change can thermally distort an optical element, for example the reflective surface of a mirror. With many types of optical systems, the intensity of radiation is normally too low to cause significant heating of the elements, the system can continue to function satisfactorily despite being heated, or any thermal-distortion effects of heating can be accommodated without any significant degradation of system performance. But, in other optical systems, especially systems used for extremely demanding imaging applications and the like, thermal distortion of one or more optical elements can degrade the system's overall optical performance to below specifications.

Certain types of optical systems are designed and constructed to such extremely tight dimensional and geometrical tolerances that serious attention must be directed to avoiding excessive heating of the constituent optical elements. Examples of such systems are astronomical telescopes, certain types of space-borne optical systems, high-power laser systems, and microlithography systems. Indeed, many types of optical systems that normally operate in a vacuum probably could benefit from such attention.

Most current microlithography systems use wavelengths of deep ultraviolet (DUV) light (λ=150 to 250 nm) for imaging purposes. To achieve further improvement of imaging resolution, substantial research is being directed to the development of practical microlithography systems that use “extreme ultraviolet” (EUV) wavelengths, in the range of 11 to 14 nm. Whereas optical systems (such as projection-optical systems) for use with DUV light are usually mostly to fully refractive, no materials are currently known that are sufficiently transmissive to EUV light and that exhibit a usable refractive index to EUV light for use in making EUV lenses. Consequently, current EUV optical systems are entirely reflective and usually comprise multiple mirrors each having a multilayer EUV-reflective coating on its reflective surface to provide the mirror with a usable reflectivity (approximately 70%, maximum) to EUV light at non-grazing angles of incidence.

Most practical EUV sources are very intense and radiate a large amount of energy. (Also, a large effort is currently underway to increase the intensity of EUV sources, particularly portable EUV sources, substantially over current sources.) EUV-reflective mirrors often experience heating during use because their multilayer reflective coatings absorb a substantial amount (with current mirrors, approximately 30% or more) of the incident EUV radiation. The mirror situated closest to the EUV source, such as the most upstream mirror in an illumination-optical system, typically absorbs more energy than any other mirror of the system. By way of example, in EUV microlithography systems currently under development for high-throughput use, the radiant-energy load for the mirror closest to the EUV source can be 1 kW or greater. This radiant load typically includes EUV light in the desired wavelength band as well as substantial out-of-band (OoB) light. Similarly, mirrors used in other high-power optical systems, such as certain laser systems, experience substantial heat loads. As the mirror absorbs energy from incident light, the mirror temperature increases. If precautions are not taken under such conditions, the mirror can experience thermal effects (e.g., expansion) that can cause an unacceptable degradation of optical performance of and possible fracture or other damage to the mirror.

To reduce thermal effects on mirrors in EUV systems, at least some of the mirrors are conventionally made of a material having a very low coefficient of thermal expansion (CTE). An exemplary low-CTE material used for making conventional EUV mirrors is ZERODUR®, made by Schott, Germany. Unfortunately, this and other low-CTE materials tend to have low thermal conductivity, which poses a challenge in removing heat at a desired rate from the reflective surface of the mirror.

A mirror of which the body is made substantially of a single material typically has a substantially uniform CTE throughout the body. If such a mirror simply experiences an overall increase in temperature, the temperature increase will be accompanied by a substantially uniform expansion of the mirror, which inevitably changes the curvature of the reflective surface of the mirror. For very demanding applications, this change can be significant. An example is shown in FIGS. 1(A)-1(B). Turning first to FIG. 1(A), the elevational profile of a conventional mirror 10 at ambient temperature is shown. The mirror 10 has a body 12, a base 14, and a reflective surface 16. The reflective surface 16 is concave at a particular radius of curvature. Heating the mirror 10 causes the mirror to expand, which results in a slight change in the radius of curvature of the reflective surface 16. The result of this change is shown in FIG. 1(B), showing the ambient-temperature mirror 10 (at the same scale as depicted in FIG. 1(A)) and a “warmer” mirror 20 (shown larger to highlight the effect). The reflective surface 26 of the warmer mirror 20 has an altered radius of curvature, as evidenced by the lack of superimposability of the respective profiles of the reflective surfaces 16, 26. Although the change in curvature radius may appear minor, such a change can substantially degrade the optical performance of the mirror especially if the mirror is used in an extremely high-precision optical system such as a microlithography system.

To reduce these and other thermal effects, any of several approaches are conventionally used for removing heat from the mirror during use. One method involves simply allowing the heat to radiate from the mirror. This method is inefficient and can provide an inadequate rate of cooling, especially of a mirror located close to the source of radiant energy. Another method involves mounting the mirror to a mass to which heat is conducted from the mirror, such as via the mirror mountings, for example. This method is also inefficient for high heat loads and can subject the mirror to high thermal and/or mechanical stresses.

Yet another conventional approach involves cooling the mirror with a temperature-regulated liquid circulated through cooling channels defined in the mirror body. This approach as currently implemented has several problems. First, it is difficult to form the channels in the mirror body, especially without having to fabricate the body of multiple pieces that are bonded together. Second, cooling channels inevitably form different thermal gradients in different portions of the mirror, such as one thermal gradient in the upper portion between the irradiated reflective surface and the cooling channels, and another thermal gradient in the lower portion between the cooling channels and the base of the mirror. Consequently, despite the mirror being liquid-cooled, the upper portion still exhibits significant thermal expansion, which changes the curvature of the reflective surface. Third, to prevent undesirable changes to the reflective surface (e.g., “print-through” of the cooling channels to the reflective surface as the reflective surface is being machined), the cooling channels must be located some distance, in the thickness dimension of the mirror, from the reflective surface. Since the reflective surface is where the cooling channels are most needed, any significant thickness of mirror body between the cooling channels and the reflective surface produces thermal gradients. Fourth, especially if the reflective surface has curvature, it is extremely difficult or impossible using cooling channels to achieve a uniform rate of heat removal from all portions of the reflective surface, simply because the body thickness between the curved reflective surface and the cooling channels typically is not uniform. Hence, different thermal gradients are established across the mirror that produce greater thermal expansion of hotter portions of the mirror (e.g., between the reflective surface and the cooling channels) relative to cooler portions. These differential expansions can produce excess mirror stress and unacceptable changes in curvature of the reflective surface.

Yet another challenge to liquid-cooling a mirror is the manner in which the liquid is circulated through the channels. More specifically, whereas turbulent flow of the liquid through the channels can yield more efficient heat-transfer and cooling than laminar flow, turbulent flow often generates vibrations within the mirror. These vibrations may be transmitted through the microlithography system, which can compromise the accuracy of microlithographic processes performed by the system.

Increasing the flow rate of the coolant through the mirror body can reduce the rate of temperature rise and the overall temperature rise of the mirror. But, increasing the flow rate may generate turbulence, and increasing the flow rate also usually does not yield any substantial change in the temperature gradients between the reflective surface and the coolant channels.

One conventional approach to reducing temperature gradients is making the mirror of a material having high thermal conductivity. However, the available materials satisfying this criterion tend to have larger CTEs, wherein a combination of high thermal conductivity and high CTE tends to produce relatively large temperature rises of the mirror during use, and consequent significant changes in mirror shape. Another conventional approach is to make the mirror of a material having a low CTE to reduce the overall expansion of the mirror during heating. However, the few available materials satisfying this criterion tend to have lower thermal conductivity. Consequently, heating the reflective surface of the mirror tends to increase the temperature gradients in the mirror (reflective surface versus the mirror body).

Yet another conventional approach to mirror cooling involves mounting the mirror's rear surface to a cooling plate. The cooling plate is actively cooled by circulating temperature-controlled liquid through cooling channels or passages formed in the plate. Unfortunately, even with such a cooling plate, the reflective surface of the mirror changes shape whenever a heat load is applied to it, because: (a) there remains a temperature gradient between the reflective surface and the cooling plate that causes the mirror to bend and, with a concave reflective surface, increase its radius of curvature; and (b) the entire mirror heats up and expands, which increases the radius of curvature of a concave reflective surface. Again, low-CTE materials reduce this problem, but they have disadvantages as discussed above.

Excessive heating of the reflective surface of a mirror also can damage the coating(s) on the surface. Furthermore, heating the reflective surface can increase radiative heat transfer from the mirror to other surfaces and components in the optical system, which can have a degradative effect overall.

Therefore, a need exists for mirrors and other optical elements, used in high-intensity optical systems and other systems in which the elements may undergo substantial heating, that exhibit reduced changes in their optical surfaces (and thus in their optical performances) while withstanding their conditions of use.

### SUMMARY

The need articulated above is satisfied by any of various aspects of the current invention, of which a first aspect is directed to optical elements. An embodiment of such an optical element comprises first and second portions. The first portion has a first coefficient of thermal expansion (CTE), an obverse surface (e.g., a reflective surface), and a reverse surface. The second portion is bonded to the reverse surface of the first portion. The second portion has a second CTE that is different from the first CTE to form an optical element exhibiting a thermally multimetallic-like change in curvature of the obverse surface accompanying a temperature change of the optical element. The second portion has a thermal-response property in a first direction that is different from a thermal-response property in a second direction. For example, the second portion can be configured to offset an astigma aberration of the optical element.

The thermal-response properties can be, by way of example, respective thickness profiles of the second portion in the first and second directions. In such a configuration at least one of the thickness profiles can be of ribs and valleys. In another example, the thermal-response properties are respective CTEs of the second portion in the first and second directions.

In certain embodiments the first portion comprises multiple layers. In other embodiments the second portion comprises multiple layers.

The first and second directions can be, but need not be, normal to each other.

Certain embodiments are configured to produce the multimetallic-like change substantially in the second portion. Other embodiments are configured to produce the multimetallic-like change cooperatively by the first and second portions.

The second portion can have a thickness profile in the first direction that is different from a thickness profile in the second direction. In certain embodiments the thickness profile in the first direction is linear, while the thickness profile in the second direction is variable. For example, the thickness profile in the first direction can be substantially constant while the thickness profile in the second direction is periodic. The thickness profile in the second direction can have substantially constant pitch or, alternatively, variable pitch.

In certain embodiments the thickness profile in the first direction comprises ribs and valleys, while the thickness profile in the second direction extends longitudinally along a rib or valley. In other embodiments the thickness profile in the first direction comprises ribs and valleys at a first pitch, while the thickness profile in the second direction comprises ribs and valleys at a second pitch. In the latter, the first and second pitches can be substantially equal or unequal. In yet other embodiments the second portion has a CTE profile in the first direction that is different from a CTE profile in the second direction.

Various embodiments can have one or more of the following features: the multimetallic-like change arises from the first and second portions having a bimetallic-like structure; the first and second portions are configured as respective layers; the first portion is internally cooled; and the first portion has a lower CTE than the second portion.

Another embodiment of an optical element comprises first and second portions. The first portion has an obverse optical surface and a reverse surface, and the second portion is bonded to the reverse surface. The second portion comprises multiple layers having respective CTEs and being bonded together in a thermally multimetallic manner that, during heating of the optical element, provides the second portion with a bending moment that at least partially offsets a change in curvature of the optical surface resulting from the heating. The second portion can comprise two layers bonded together in a thermally bimetallic manner, wherein the two layers of the second portion can have different respective thicknesses. Alternatively, the two layers of the second portion can comprise a first layer bonded to the reverse surface of the first portion and a second layer bonded to the first layer, wherein the first layer has a lower CTE than the second layer.

In other embodiments at least one of the layers of the second portion has a variable thickness.

In yet other embodiments the second portion comprises three layers bonded together in a thermally trimetallic manner. At least two of the layers of the second portion can have different respective thicknesses. Alternatively, the three layers of the second portion can comprise a first layer bonded to the reverse surface of the first portion, a second layer bonded to the first layer, and a third layer bonded to the second layer, wherein the second layer has a lower CTE than the third layer.

In certain embodiments the second portion is internally cooled.

In certain embodiments at least one layer of the second portion is tuned according to a variable property of the first portion. The variable property can be thickness or CTE, for example.

According to another aspect of the invention, optical systems are provided that comprise an optical element such as any of the embodiments summarized above.

According to another aspect of the invention, exposure systems are provided that comprise an optical system as summarized above.

According to another aspect of the invention, microelectronic-device manufacturing processes are provided that comprise at least one pattern-exposure step including use of an exposure system as summarized above.

According to yet another aspect, methods are provided for correcting radiation-induced thermal deformation of a reflective optical element having a respective CTE, a reflective surface arranged to receive radiation, and a reverse surface. An embodiment of such a method includes the step of providing on the reverse surface a correcting portion having a respective CTE that is different from the CTE of the optical element sufficiently to cause differential thermal expansion, in a thermally multimetallic manner, of the correcting portion relative to the optical element. The correcting portion is provided with a thermal-response property in a first direction that is different from a thermal-response property in a second direction. As radiation is received by the optical element and heats the reflective surface, the correcting portion is allowed to impart a bending moment to the optical element that at least partially offsets a thermal deformation of the reflective surface resulting from the heating.

In another embodiment of a method for correcting radiation-induced thermal deformation of a reflective optical element, a correcting portion is formed that includes at least two layers of respective materials having respective CTEs that are sufficiently different to cause the correcting portion to exhibit a multimetallic-like bending moment when heated. The correcting portion is attached to the reverse surface of the optical element. As radiation is received by the optical element and heats the reflective surface, the correcting portion is allowed to apply its bending moment to the optical element that at least partially offsets a thermal deformation of the reflective surface resulting from the heating.

The foregoing and additional features and advantages of the invention will be more readily apparent from the following detailed description, which proceeds with reference to the accompanying drawings.

### BRIEF DESCRIPTION OF THE DRAWINGS

FIG. 1(A) is an elevational view of a conventional mirror having a concave reflective surface.

FIG. 1(B) is an elevational view of the mirror of FIG. 1(A) before heating (smaller profile) and after heating (larger profile), with their respective reflective surfaces registered with each other to depict the change (increase) in the curvature radius of the reflective surface upon heating.

FIG. 2(A) is an elevational view of an embodiment of a mirror, including two body layers (defining coolant conduits between them), a reflective surface, and a correcting portion configured to correct thermal deformation of the reflective surface; the conduits have rectangular transverse profiles.

FIG. 2(B) is an elevational view of an embodiment of a mirror, including a unitary body (in which coolant conduits have been formed), a reflective surface, and a correcting portion configured to correct thermal deformation of the reflective surface; the conduits have round transverse profiles.

FIG. 2(C) is an elevational view of an embodiment of a mirror, including one body layer (no coolant conduits), a reflective surface, and a correcting portion configured to correct thermal deformation of the reflective surface.

FIG. 2(D) is an elevational view of an embodiment of a mirror, including two body layers (in which coolant conduits have been formed), a reflective surface, and a correcting portion configured to correct thermal deformation of the reflective surface. The upper body layer is a constant thickness with a concave reflective surface, and the conduits are at a uniform depth relative to the reflective surface.

FIG. 3(A) is a plan view of an embodiment of a mirror in which the cooling conduits are in a parallel-flow configuration.

FIG. 3(B) is a plan view of an embodiment of a mirror in which the cooling conduits are in a serpentine, series-flow configuration.

FIG. 3(C) is a plan view of an embodiment of a mirror in which the cooling conduits are in a rectilinear, series-flow configuration.

FIG. 3(D) is a plan view of an embodiment of a mirror in which the cooling conduits are in a radial-flow configuration.

FIG. 4(A) is an elevational view of an embodiment of a mirror having a unitary body, a reflective surface, and a correcting portion configured to correct thermal deformation of the reflective layer; cooling conduits are formed at the interface between the correcting portion and the body.

FIG. 4(B) is an elevational view in the form of superposition of the respective reflective surfaces of the mirror of FIG. 4(A) before heating (smaller profile) and after heating (larger profile), illustrating the correction imparted by the correcting portion to the reflective surface. The “after heating” profile is larger than the “before heating” profile to depict more clearly the correction to the reflective surface.

FIG. 5 is an elevational view of a mirror embodiment in which the thickness of the correcting portion is varied in accordance with variations in the thickness of the front layer of the mirror body. In this instance, the reflective surface is concave, and the coolant conduits have an elongated rectangular transverse profile in this view.

FIG. 6(A) is an elevational view of a mirror embodiment comprising a correction portion having two layers.

FIG. 6(B) is an elevational view of a mirror embodiment comprising a correction portion having three layers.

FIG. 7 is an elevational view of a mirror having an annular-shaped illumination area on the reflective surface, according to the second representative embodiment. Coolant conduits are situated in regions, between the mirror body and thermally correcting portion, corresponding to illuminated regions of the reflective surface, and the correcting portion has a thickness profile that corresponds to the illuminated regions of the reflective surface.

FIG. 8 is an elevational view of a mirror similar to that shown in FIG. 5, but including some exemplary dimensions, according to the first representative embodiment.

FIG. 9 is a plan view of a mirror having an annular-shaped cooling conduit corresponding to an annular-shaped illumination region on the reflective surface of the mirror. See the second representative embodiment.

FIGS. 10(A)-10(B) are orthogonal views of a mirror having a reflective surface with different curvature radii in the x- and y-directions, and a correcting portion having a thickness profile corresponding to the shape of the reflective surface, according to the third representative embodiment.

FIG. 11 is a perspective view of a mirror as described in Example 1. The grid is for finite-element analysis and not part of an actual mirror.

FIGS. 12(A)-12(B) are, with respect to Example 1, respective plots of peak-to-peak surface distortion versus CTE of the correcting portions in mirrors in which the correcting portion had a thickness of 8 mm and of 5 mm, respectively.

FIG. 13 is a perspective view of a mirror as described in Example 2. The grid is for finite-element analysis and not part of an actual mirror.

FIG. 14(A) is a perspective view of an exemplary power or defocus aberration of a mirror resulting from mirror heating, which can be corrected by uniform-thickness correcting portions and certain correcting portions having a radially symmetrical variation in thickness, as described in the fourth representative embodiment.

FIG. 14(B) is a perspective view of an exemplary astigma aberration of a mirror resulting from mirror heating, which can be corrected by certain correcting portions having a non-uniform thickness, especially in one direction relative to another direction. The astigma is exemplified by a “saddle” topography of the mirror surface, as described in the fourth representative embodiment.

FIG. 15 is a perspective view of a mirror according to the fourth representative embodiment, in which the variable-thickness correcting portion has a ribbed configuration.

FIG. 16 is a plan schematic, in connection with the fourth representative embodiment, showing several ribs and channels and depicting relative expansions in two dimensions.

FIG. 17 is an elevational view of a mirror, according to an alternative configuration of the fourth representative embodiment, having a correcting portion in which the ribs have a serpentine transverse profile rather than the rectilinear profile shown in FIG. 15.

FIG. 18(A) is a plan view of a mirror, according to the fifth representative embodiment, having a correcting portion in which the ribs are wide and the channels narrow, or vice versa.

FIG. 18(B) is an elevational view of the mirror shown in FIG. 18(A), in which the ribs are narrow and the channels are wide.

FIG. 18(C) is an elevational view of an alternative configuration of the mirror of FIG. 18(B), in which the ribs are wide and the channels are narrow.

FIG. 19(A) is a plan view of a mirror, according to the sixth representative embodiment, in which the correcting portion includes ribs having variable pitch.

FIG. 19(B) is an elevational view of the mirror of FIG. 19(A).

FIG. 20 is a plan view of a mirror, according to an alternative configuration of the sixth representative embodiment, in which the correcting portion includes ribs that extend in two dimensions and thus intersect each other at right angles.

FIG. 21 is a block diagram of an EUV microlithography system embodiment comprising at least one mirror as described herein.

FIG. 22 is a block diagram of the illumination-optical system of the EUV microlithography system of FIG. 21.

FIG. 23 is a block diagram of a method for fabricating micro-devices, the method including performing a microlithography step using a microlithography system as described herein.

FIG. 24 is a block diagram of the microlithography step used in the method of FIG. 23.

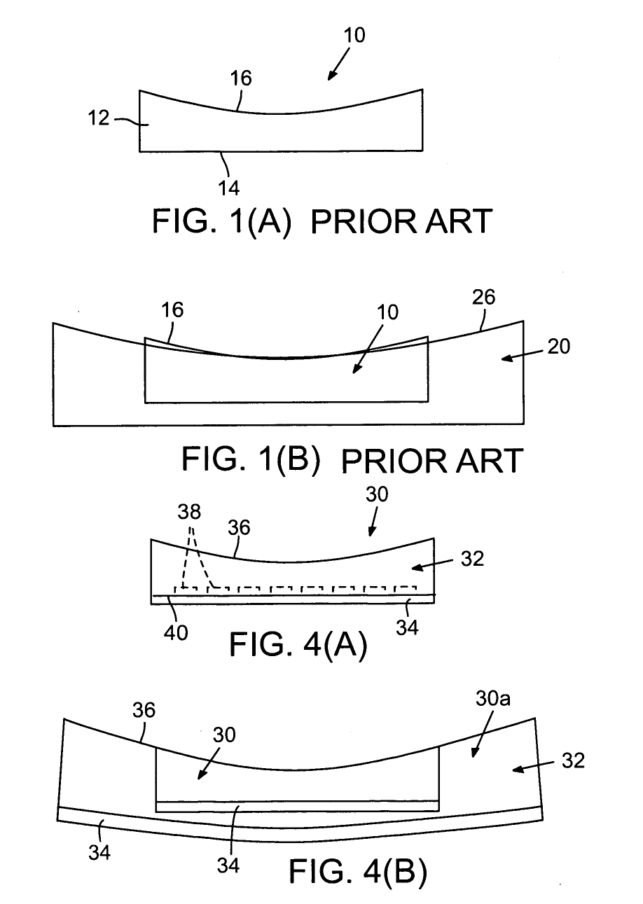

### DETAILED DESCRIPTION

This disclosure is set forth in the context of representative embodiments that are not intended to be limiting in any way.

In the following description, certain terms may be used such as “up,” “down,”, “upper,” “lower,” “horizontal,” “vertical,” “left,” “right,” and the like. These terms are used, where applicable, to improve clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

The following description is set forth in the context of “mirrors” as exemplary optical elements. Representative mirrors include, but are not limited to, planar mirrors, collimator mirrors, beam-expanding mirrors, condenser mirrors, and fly-eye mirrors. It will be understood that the principles described below can also be utilized with other types of optical elements having an optical surface that is vulnerable to thermal effects of radiant heating. These other types of elements may be any of, for example, reflective gratings, filters, prisms, and the like. Each such element comprises at least one optical surface (e.g., a reflective surface) that can be curved or planar. If curved, the optical surface can be spherical or aspherical. The optical surface can be configured for on-axis or off-axis illumination. The optical surface can be surficial or embedded, the latter as in certain prisms for example. Hence, in the following, use of the word “mirror” will be understood to encompass these other types of optical elements as well.

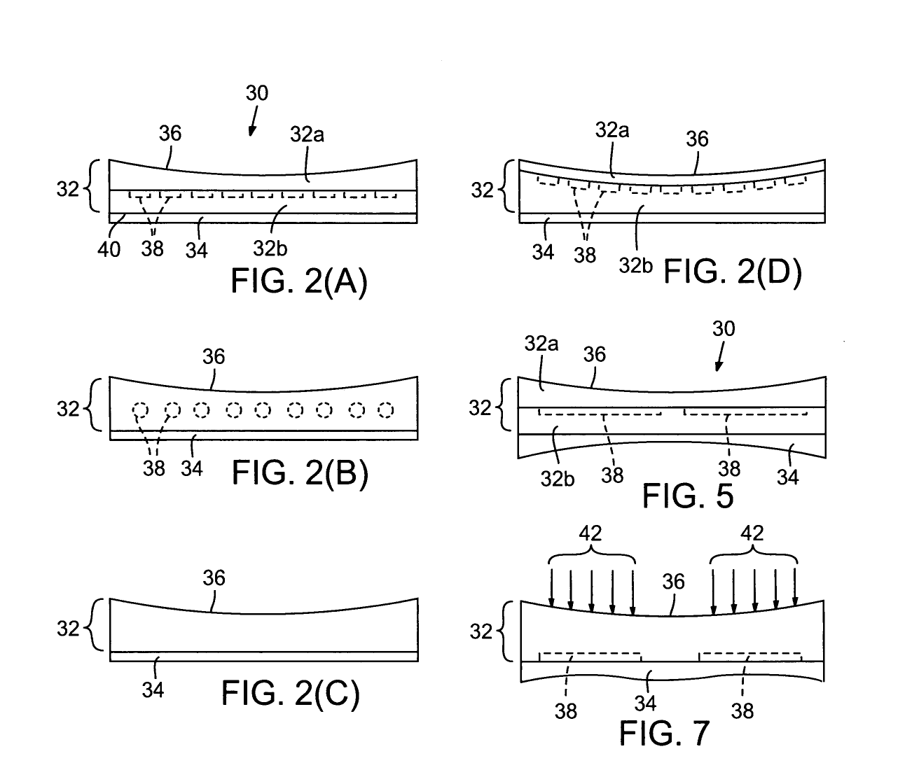

Referring, e.g., to FIG. 2(A), various embodiments of a mirror 30 comprise a body 32 having an optical surface 36 that is at least partially reflective to incident light. Hence, the reflective portion of the surface 36 (which can be the entire surface 36) is generally termed a “reflective surface.” The surface 36 is also termed an “obverse surface.” The body 32 also has an opposing, or “reverse,” surface 40. In a plan view (viewed from above the reflective surface) the body 32 can have any of various shapes such as (but not limited to) round, rectilinear, arc-shaped, polygonal, annular, or irregular. The reflective surface 36 can cover the entire surface visible in the plan view or alternatively can cover discrete portion(s) of the surface. Although the surface 36 is depicted as being concave, this is not intended to be limiting. Some embodiments have a planar surface 36, for example. It also will be understood that the surface 36 could be convex in certain embodiments.

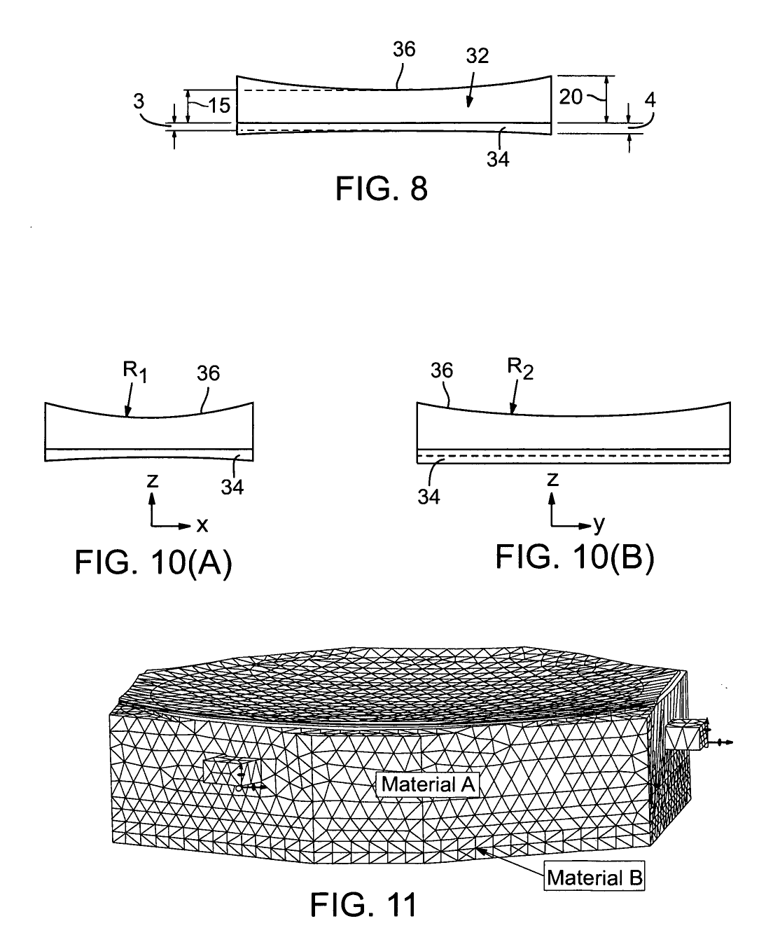

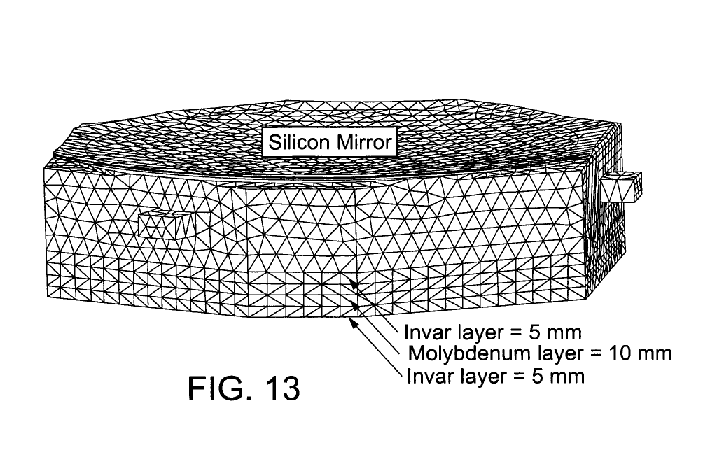

The mirror 30 desirably is mounted in a kinematic manner to a suitable base or frame (not shown). To such end, the mirror 30 can include mounting ears or tabs (not shown, but see FIGS. 10 and 13) for attachment to respective mounting devices (not shown). If the mirror is mounted using mounting ears or tabs, typically three mounting ears or tabs are provided on the mirror (again, see FIGS. 10 and 13). A “kinematic” mounting is one that is collectively constrained in the six degrees of freedom (X, Y, Z, θ_{X}, θ_{Y}, θ_{Z}) but not by each of the mounting devices. For example, a kinematic mounting can comprise three mounting devices to hold the mirror (one mounting device for each mounting ear or tab), wherein each mounting device provides two respective degrees of freedom. By mounting the mirror 30 kinematically, the mirror is not overly constrained, and the mounting devices themselves do not cause any significant distortion of the mirror.

### Internal Cooling of Mirror

Incidence of radiant energy on the optical surface 36 heats the mirror. To remove the heat the mirror 30 can be internally cooled or not internally cooled. Mirrors that are internally cooled comprise one or more conduits 38 usually located in the body 32 of the mirror. A liquid coolant is circulated through the conduits 38. The coolant desirably is temperature-regulated (e.g., maintained at a desired temperature using a feedback-controlled temperature-regulating device such as used in a closed-loop circulating liquid-coolant bath), and is circulated desirably at a controlled flow rate. The flow of coolant can be under laminar-flow or turbulent-flow conditions, depending upon circumstances of use. (E.g., turbulent flow may be tolerable in a fly-eye mirror but may not be tolerable in a collimator mirror.) A particular advantage of the mirror embodiments described below, however, is that in certain instances the internal conduits can be eliminated, which provides more options for mirror configurations and reduces mirror cost.

In some embodiments the at least one conduit 38 is defined in a unitary (one-piece) body 32, if practical, such as shown in FIG. 2(B). See also FIG. 4(A). In other embodiments, the body 32 comprises multiple (at least two) body portions 32a, 32b, wherein the conduit(s) 38 are defined in a respective face of at least one body portion and the faces are subsequently bonded together to define the conduit(s) in the body. The body portion 32a is an “upper” portion, and the body portion 32b is a “lower” portion. Examples are shown in FIGS. 2(A) and 2(D). Generally, forming the conduits 38 using multiple body portions 32a, 32b is advantageous mostly for ease of manufacture of a mirror including the conduits. The body portions 32a, 32b can have any of several configurations. FIG. 2(D) depicts one embodiment having an upper body portion 32a of which the upper face is the curved reflective surface 36 and the lower face substantially follows the curvature of the upper surface. FIG. 2(A) depicts another embodiment having an upper body portion 32a of which the lower face does not follow the curvature of the reflective surface 36 (e.g., is substantially planar).

The body portions 32a, 32b can be made of the same material (which is desirable) or of different materials. Example materials include, but are not limited to, silicon, ceramic, glass, quartz, ZERODUR® (Schott, Germany), copper, and invar.

In various embodiments of a multi-portion mirror body 32, the body portions 32a, 32b are bonded together by a suitable bonding method that provides good thermal conductivity between the body portions and that does not interfere with the optical function of the mirror 30. Example bonding methods include, but are not limited to, soldering, brazing, frit-bonding, and use of adhesive (e.g., high-thermal-conductivity epoxy). Frit-bonding yields a glass bond; this method can also be used to join the outside edges of the body portions 32a, 32b. The particular bonding method selected will depend largely upon the respective materials from which the body portions 32a, 32b are made. Bonding desirably is performed “internally” (at the interface of the body portions 32a, 32b) and “externally” (around the outside edges of the body portions). Bonding the outside edges effectively seals the body 32. Usually, the same bonding material is used for internal and external bonding purposes. The body portions 32a, 32b desirably are bonded together in a continuous manner, in contrast to discrete attachment (e.g., screws or pins) to enable good thermal conductivity between the body portions. Also, the selected bonding material and method desirably yield a bond that is resistant to creep.

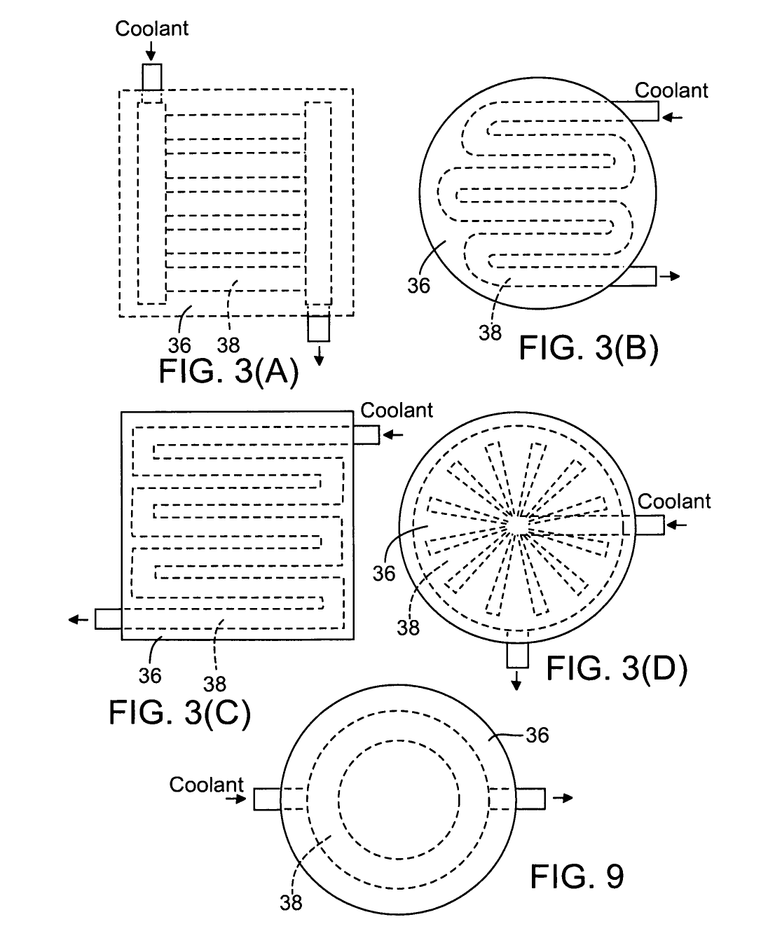

The conduits 38 can have any of various transverse profiles in various embodiments. See, e.g., FIGS. 2(A), 2(B), 2(D), 4(A). The transverse profiles of the conduits 38 can be all the same shape and dimensions or alternatively can be different shapes and/or dimensions. The conduit(s) 38 can be arranged in any of various ways in the body 32 of the mirror 30, and the arrangements can be simple or complex, or a combination of simple and complex. Example simple arrangements include, but are not limited to, parallel-flow arrangements (see example in FIG. 3(A)), series-flow arrangements (e.g., FIGS. 3(B) and 3(C)), rectilinear-flow arrangements (FIG. 3(C)), radial-flow arrangements (FIG. 3(D)), serpentine-flow arrangements (FIG. 3(B)), spiral-flow arrangements, etc., and combinations thereof. Other arrangements, including more complex arrangements (some of which including micro-channels), are discussed in U.S. patent application Ser. No. 11/382,342, filed on May 9, 2006, incorporated herein by reference.

The particular configuration and orientation of conduits 38 are selected based on various factors such as desired flow dynamics of the coolant, type of coolant, temperature of the coolant, desired rate of cooling of the mirror, area of the mirror to be cooled, desired pressure drop in the conduits, etc. In a particular embodiment, use of conduits having substantially the same dimensions may provide relatively uniform heat removal if the incident radiation on the reflective surface is approximately uniform. In an alternative embodiment, the dimensions associated with the conduits and their arrays can be varied to compensate for non-uniformities in the incident radiation. I.e., the heat-transfer rate associated with the mirror can be varied across the reflective surface by implementing different dimensions and layouts of the conduits.

Various coolants can be used such as, but not limited to, water and any of various fluorocarbon liquids. In general, if laminar flow is desired, laminar flow usually has a Reynold's number less than approximately 2000.

### Mirror Correcting Portion

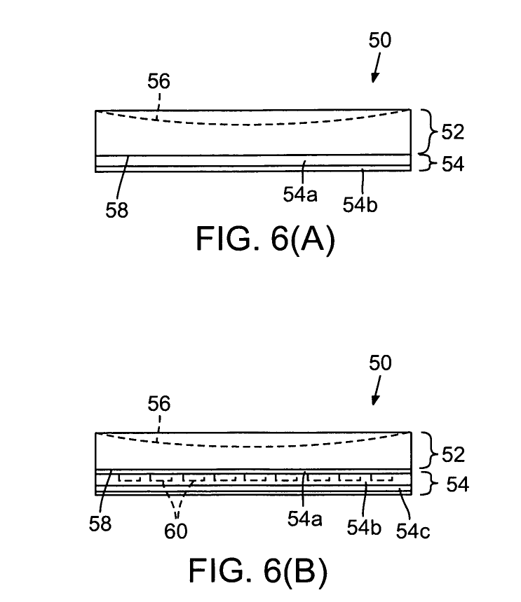

Referring to FIG. 2(A) for example, the various mirror embodiments comprise, in addition to the single- or multi-piece body 32, a “correcting portion” 34 (also called a “correcting plate”). The correcting portion 34 can be internally cooled or not internally cooled. As with the mirror, internal cooling is achieved by circulating a coolant through channels associated with the correcting portion. See FIG. 6(B), which shows exemplary cooling channels 60 in the correcting portion 54.

Referring further to FIG. 2(A), the correcting portion 34 is bonded to the lower face of the body 32 (or rear face of the body portion 32b) desirably in a continuous manner. The bonding method can be generally the same as described above for joining body portions 32a, 32b together. Bonding desirably is achieved by a method that provides good thermal conductivity between the body 32 and the correcting portion 34 and that provides a sound bond that resists creep. In certain embodiments, mechanical fasteners such as pins, screws, or the like, can be used for this purpose. Use of fasteners represents a “discrete attachment” method, of which one possible disadvantage is susceptibility to hysteresis due to shear slip at the interface between the correcting portion 34 and the lower face of the body 32. Mechanical fasteners also may not always provide sufficient thermal contact between the correcting portion 34 and body 32 and/or may concentrate stresses at certain locations on the body and correcting portion. “Continuous-bonding” methods include, but are not limited to, soldering (using, e.g., silver solder), brazing, welding, frit-bonding, and use of adhesive (e.g., high-thermal-conductivity epoxy). Adhesive-bonding may be enhanced by roughening the surfaces beforehand. Frit-bonding yields a glass bond. The particular bonding method selected will depend largely upon the material(s) from which the body 32 (or body portion 32b) is made and the anticipated conditions of use of the mirror. A particular bonding method does not work satisfactorily on all materials. The bonding method is also selected based upon whether the materials of the mirror and correcting portion can withstand the temperature required to achieve a satisfactory bond. Desirably, excess temperatures during bonding are avoided, if practical. The resulting bond should enable good thermal conduction between the mirror body and the correcting portion.

The correcting portion 34 can comprise a single layer or can comprise multiple layers. Single-layer configurations are discussed first, below, followed later by discussion of multiple-layer configurations. The term “correcting portion” is not meant to indicate or imply that the subject portion necessarily works alone to correct the optical surface. In some embodiments the correcting portion works in coordination with the mirror body to produce correction; in other embodiments the correcting portion can work without substantial contribution by the mirror body to produce correction.

### Single-Layer Correcting Portion

In, e.g., the embodiment of FIG. 2(A), the correcting portion 34 operates cooperatively with the mirror body 32 to produce a “bimetallic-like” corrective effect on mirror curvature. A “bimetallic-like” corrective effect is based upon the bimetallic-strip phenomenon exhibited by a strip formed of two dissimilar metals (having different CTEs) welded together, wherein the different CTEs cause the strip to bend or curl as its temperature changes. Since the correcting portion 34 in this embodiment is a single layer, the bimetallic-like effect is produced by the mirror body 32 and the correcting portion 34 acting together. The correcting portion 34 desirably is made of a material having a higher CTE than the material(s) of the body 32. The correcting portion 34 also desirably has relatively high thermal conductivity and low heat capacity. (Materials having a high thermal conductivity and low heat capacity tend to exhibit, inter alia, better transient responses to changes in the duty cycle of illumination on the mirror body 32.) Exemplary materials for the correcting portion 34 include, but are not limited to, copper, ceramic, silicon, SiC, aluminum, molybdenum, invar, alloys of these materials, and the like.

By way of example, the body 32 and correcting portion 34 can be made of similar but slightly different materials (e.g., different respective alloys of a metal such as copper or the same metal differently doped) having different respective CTEs. High-conductivity materials tend to have low thermal gradients, so little change in temperature distribution in the mirror body 32, or in the mirror shape, would be realized whether or not the mirror is receiving illumination energy. Other factors that desirably are considered include the elastic modulus of the material of the correcting portion 34 and the relative thicknesses of the body 32 and correcting portion 34.

The difference in CTE of the two materials can be very slight (see Example 1). I.e., the CTE of the correcting portion 34 need not be much higher than of the body 32; in many instances only a slight difference is sufficient to achieve the desired degree of bimetallic-like effect. Referring to FIG. 4(B), for example, as the overall temperature of the mirror 30 increases due to absorption of radiant energy at the reflective surface 36, the body 32 exhibits a thermal expansion that, in the absence of a countervailing effect, tends to increase the radius of curvature of a concave reflective surface. The correcting portion 34 is configured to bend naturally in an upwardly concave manner when heated. Since the body 32 and correcting portion are bonded together, as the correcting portion 34 heats up, it imparts a bending moment to the mirror that tends to reduce the curvature radius of the reflective surface 36. Specifically, the concave deformation of the correcting portion 34 reduces the radius of curvature of the reflective surface 36, which in turn offsets the natural increase in the radius of curvature accompanying mirror heating. Hence, the bending moment of the correcting portion 34 compensates for (offsets, reduces, or even substantially cancels) the thermal expansion of the body 32. The material and properties of the correcting portion 34 can be selected so that the curvature radius of the reflective surface 36 remains substantially unchanged as the mirror heats up. (In FIG. 4(B), note the near perfect superposition of the curves denoting the respective reflective surfaces 36.)

The correcting portion 34 can have a uniform thickness, as shown in FIGS. 2(A)-2(D) and 4(A)-4(B). Alternatively, the correcting portion 34 can have a variable thickness as shown for example in FIGS. 5 and 7. Other embodiments in which the correcting portion has non-uniform thickness are discussed later below. In various embodiments, variable thickness of the correcting portion is an important aspect of “tuning.”

### Multiple-Layer Correcting Portion

Alternatively to a single layer or plate, the correcting portion can comprise multiple (two or more) layers. As discussed above, a single-layer correcting portion cooperates with the mirror body to produce a bimetallic-like correction of mirror curvature. In certain embodiments a multiple-layer correcting portion works similarly to a single-layer correcting portion. In other embodiments a multiple-layer correcting portion produces its own bimetallic-like or other “multimetallic-like” effect that can minimize or eliminate the need for a contribution by the mirror body to a multimetallic-like effect. (In generally, a “multimetallic-like” effect is a bimetallic-like effect produced by two or more layers; hence, multimetallic-like encompasses bimetallic-like.) This multimetallic-like effect produced by the multiple-layer correcting portion alone can be sufficient for correcting mirror curvature, and is especially advantageous for correcting mirror curvature while reducing or substantially eliminating shear stress between the correcting portion and the mirror. In other words, in these embodiments the multimetallic-like (e.g., bimetallic-like or trimetallic-like, depending upon the number of layers in the correcting portion) effect is produced substantially by the correcting portion, with minimal contribution by the mirror body.

A multiple-layer correcting portion can be internally cooled or not internally cooled. The discussion above regarding internal cooling of the mirror is applicable to internal cooling of the correcting portion. As with mirrors, exemplary coolants for cooling the correcting portion are water and any of various liquid fluorocarbons.

In certain embodiments the correcting portion comprises two layers, as shown generally in FIG. 6(A), that collectively produce a bimetallic-like effect. The two-layer embodiment of FIG. 6(A) comprises a mirror 50 including a mirror body 52 and a correcting portion 54. The mirror body defines an optical surface 56 (e.g., reflective surface) and a reverse surface 58. The correcting portion 54 is bonded to the reverse surface 58 and comprises a first layer 54a and a second layer 54b.

An example embodiment in which the correcting portion has three layers is shown in FIG. 6(B), which depicts a mirror 50 comprising a mirror body 52 and a correcting portion 54. The correcting portion 54 comprises a first layer 54a, a second layer 54b, and a third layer 54c that collectively produce a “trimetallic-like” effect. It is noted that the correcting portion 54 can comprise more than three layers, but the respective contributions from individual layers tend to decrease in correcting portions comprising more than three layers. A three-layer correcting portion 54 can provide more “tuning” latitude than a two-layer correcting portion.

Exemplary materials for the layers of the correcting portion 54 are, but are not limited to, copper, ceramic, silicon, SiC, aluminum, invar, molybdenum, and the like, as well as alloys of these materials. The differences in CTE among the layers of the correcting portion 54 can be very slight.

By way of example, in a two-layer correcting portion 54 the two constituent layers have slightly different CTEs and are usually made of different materials (even if only slightly different) and have different thicknesses (although different thicknesses are not required). In embodiments in which the mirror 50 has a concave reflective surface 56, the materials and thicknesses of the layers of the correcting portion 54 can be selected so that the correcting portion has a “zero-heat-load” curvature and bends naturally in a concave direction when heated. This concave deformation is used for canceling the natural convex deformation of the mirror that occurs as the mirror is heated. This selection of materials and thicknesses of the layers of the correcting portion 54, as well as temperature and flow rate of coolant (if used) circulating through the correcting portion are examples of “tuning,” discussed later below.

The average CTE of the correcting portion 54 also desirably is selected (by selecting layer materials and respective thicknesses) to minimize the shear stress in the interface between the correcting portion and the mirror body 52. Achieving this minimal shear stress reduces, inter alia, the possibility of “creep” in the bond of the correcting portion 54 to the mirror body 52 (creep can change the curvature correction over time).

### Tunable Correcting Portion

The correcting portion 34, 54 can be “tuned,” which in many embodiments involves a change in its thickness. The change can be the same overall or can be variable from region to region of the correcting portion and/or in one direction relative to another direction. To such end the correcting portion 34, 54 can have a uniform thickness or a variable thickness, as discussed generally above.

In some embodiments involving tuning, the thickness of the correcting portion is changed overall in accordance with its particular CTE to optimize the compensation the correcting portion provides to the reflective surface of the mirror. For example, before manufacturing the mirror, the respective CTEs of the body (or body portions) and correcting portion can be accurately measured. (The CTE of a given material frequently varies, usually slightly, from one manufacturing batch of the material to another. This variation can be a significant variable in certain optical systems.) The thickness of the correcting portion, or the relative thicknesses of the body and correcting portion, can be adjusted during manufacture of the mirror to optimize the compensation.

By way of example, two different batches of material used for fabricating the body have respective CTEs: C_{A} and C_{B}, wherein C_{A} is slightly lower than C_{B}. A mirror in which the body is made of the C_{A} batch of material could be made with a correspondingly slightly thicker correcting portion to achieve the desired compensation to the curvature of the reflective surface. A mirror in which the body is made of the C_{B} batch of material would include a correspondingly slightly thinner correcting portion. In a mirror-fabrication facility, CTE data on incoming materials can be readily determined in the laboratory, such as at receiving-inspection, or supplied by the manufacturer of the material with the actual shipment of material to the mirror fabricator.

In other embodiments, the thickness of the correcting portion (or of one or more layers thereof) is varied in particular regions rather than to the same degree overall. For example, the correcting portion can be tuned differently in some locations, compared to other locations, to achieve more complete or more accurate correction of the reflective surface, e.g., to reduce or prevent asphericity of the reflective surface during heating of the mirror. In this regard, the variation of thickness of the correcting portion of the mirror can, but need not unless required, follow any corresponding variation in the body. The thickness variation can be according to a particular pattern or can be irregular.

In embodiments in which the correcting portion is internally cooled, the materials, thicknesses, and flow rate of coolant can be tuned for a given mirror body to produce a desired deformation of the correcting portion. The zero-heat-load curvature of the correcting portion 54 can be changed (“tuned”) by minor adjustment from ambient of the temperature of the coolant entering the correcting portion. If the target coolant inlet temperature is maintained and the mirror is properly tuned to exhibit no change in curvature, then this method will work for any power input to the mirror by incident radiation. Bending effects are proportional to the steady-state heat load, so the compensation is normally effective over a range of power settings.

### First Representative Embodiment

In this embodiment the thickness of the correcting portion 34 is varied according to variations in the thickness of the body 32. In FIG. 5 the mirror 30 includes a concave reflective surface 36 defined by the upper surface of the body 32. In FIG. 8 the edge thickness of the body 32 is 20 units, and the axial thickness is 15 units. To achieve the desired compensation to the curvature of the reflective surface 36 upon heating of the mirror, the correcting portion 34 is formed having an edge thickness of 4 units and an axial thickness of 3 units. Thickness ratios may be followed; note that 20/15=4/3 in FIG. 8.

### Second Representative Embodiment

In this embodiment the thickness of the correcting portion 34 is varied in accordance with whether the corresponding region of the reflective surface 36 is illuminated or not illuminated. FIG. 7 shows a situation in which the irradiated portion (irradiation denoted by arrows 42) of the reflective surface 36 is annular. The correcting portion 34 has a variable thickness profile that is thicker in regions corresponding to illuminated regions of the reflective surface 36, to provide the desired compensation to the curvature of the reflective surface. An exemplary coolant conduit 38 for this mirror is shown in FIG. 9.

### Third Representative Embodiment

If the mirror 30 is not round and/or if the reflective surface 36 does not have the same nominal radius of curvature in each of the x- and y-directions, the correcting portion can be configured to impart an astigmatic correction to the reflective surface, as shown in FIGS. 10(A)-10(B). With respect to the reflective surface, note that R₂>R₁ in FIG. 10(A), and the correcting portion is configured to have a particular radius of curvature in the x-direction and an infinite radius of curvature in the y-direction.

### EXAMPLE 1

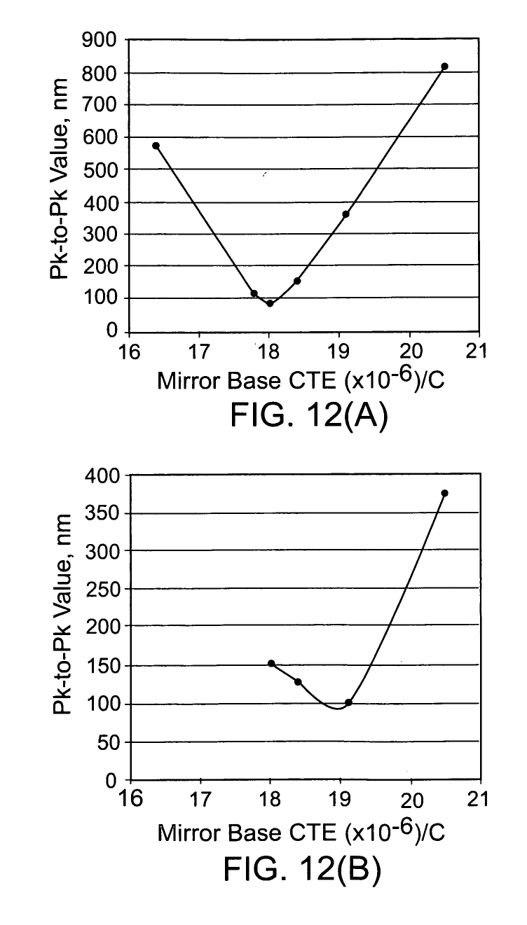

In this example, mirrors were fabricated having a configuration as generally shown in FIG. 11. The material of the mirror body was a copper alloy (“Material A”) having a CTE of 16.4×10⁻⁶/° C. The mirrors had a roughly octagonal plan profile, and included three mounting ears (two are visible in the drawing). The mirrors were not internally cooled, and were evaluated at a temperature of 4° C. above ambient temperature. A first group of mirrors was evaluated, of which the correcting portion (“Material B”) was 8 mm thick copper alloy but had slightly different CTEs, and a second group of mirrors was fabricated, of which the correcting portion was 5 mm thick copper alloy but had slightly different CTEs. In each group, individual mirrors were evaluated in which the CTE of the correcting portion was the variable. With each mirror, the peak-to-peak surface distortion (in nm) was evaluated. Results are shown in FIGS. 12(A)-12(B). In FIG. 12(A) the minimum surface distortion was exhibited when the correcting portion, at a thickness of 8 mm, had a CTE of 18×10⁻⁶/° C. In FIG. 12(B) the minimum surface distortion was exhibited when the correcting portion, at a thickness of 5 mm, had a CTE of 19×10⁻⁶/° C.

### EXAMPLE 2

This example is shown in FIG. 13. The mirror has an octagonal profile and is made of silicon, which has a CTE of 2.6 ppm/° C. The correcting portion has three layers including a first invar layer 5 mm thick, a molybdenum layer 10 mm thick, and a second invar layer 5 mm thick. Invar has a CTE of approximately 1 ppm/° C., and molybdenum has a CTE of approximately 5 ppm/° C.

### Directional Thermal-Response Property

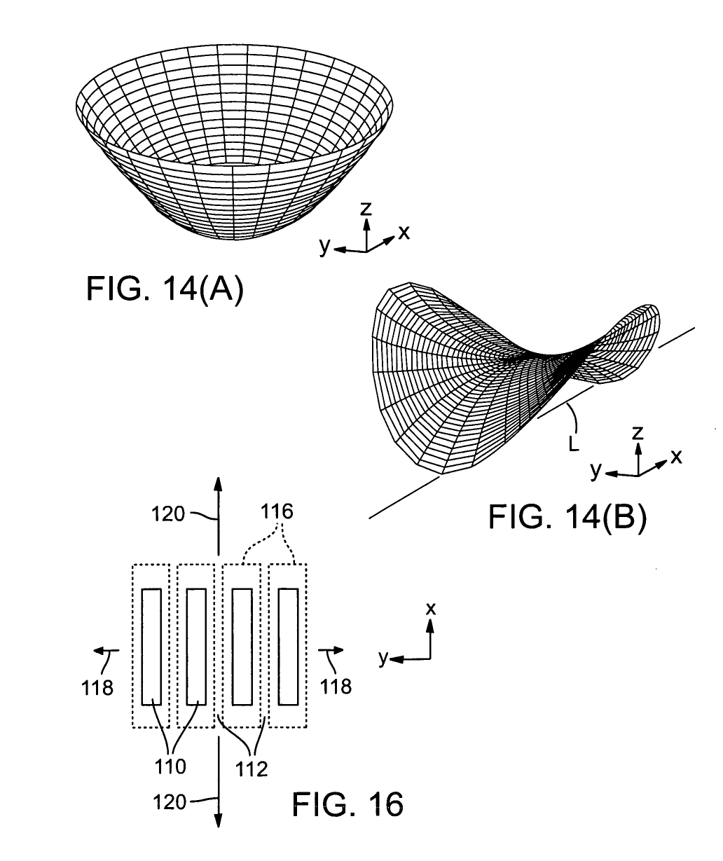

Uniform-thickness correcting portions and certain correcting portions having a radially symmetrical variation in thickness can compensate effectively for power or defocus aberrations of a mirror (see FIG. 14(A)) arising from mirror heating. However, these types of correcting portions are typically ineffective for correcting astigma aberrations (FIG. 14(B)). In FIG. 14(B), the astigma is exemplified by a “saddle” topography of the mirror surface. Astigma can arise from, for example, non-uniform heating of the mirror in the X and Y directions, or the mirror having an irregular shape.

To provide correction of astigma and related aberrations, certain embodiments of optical elements comprise first and second portions as follows. The first portion has a first CTE and an obverse surface serving as the optical surface (e.g., reflective surface). The second portion is bonded to the reverse surface of the first portion in the manner described above. The second portion has a second CTE that is different from the first CTE to form a thermally “multimetallic-like” (which can be bimetallic-like) optical element that offsets changes in curvature of the obverse surface accompanying heating of the optical element. To correct astigma, the second portion has a thermal-response property in a first direction that is different from the thermal-response property in a second direction. The thermal-response property can be, for example, a different thickness profile in the first direction versus the second direction, or a different CTE profile in the first direction versus the second direction. The first and second directions are, in many embodiments, the X and Y directions, respectively.

A different CTE profile in the first direction versus the second direction can be achieved by differentially doping a layer of the second portion. For example, a first dopant or concentration of dopant can be added to certain regions, and a second dopant or concentration of dopant can be added to other regions of the layer. Regions receiving the first dopant can be arranged as longitudinal stripes, for example. The differently doped regions have slightly different CTEs.

### Fourth Representative Embodiment

This embodiment is directed to a representative configuration that can provide astigma correction as well as correction of defocus aberrations. The general concept in this and related embodiments is to vary the thickness profile of the correcting portion in one dimension of the mirror compared to another dimension of the mirror, or to vary the thickness profile more in one direction compared to another direction. Thus, the mirror has a thermal-response property in a first direction that is different from a thermal-response property in a second direction.

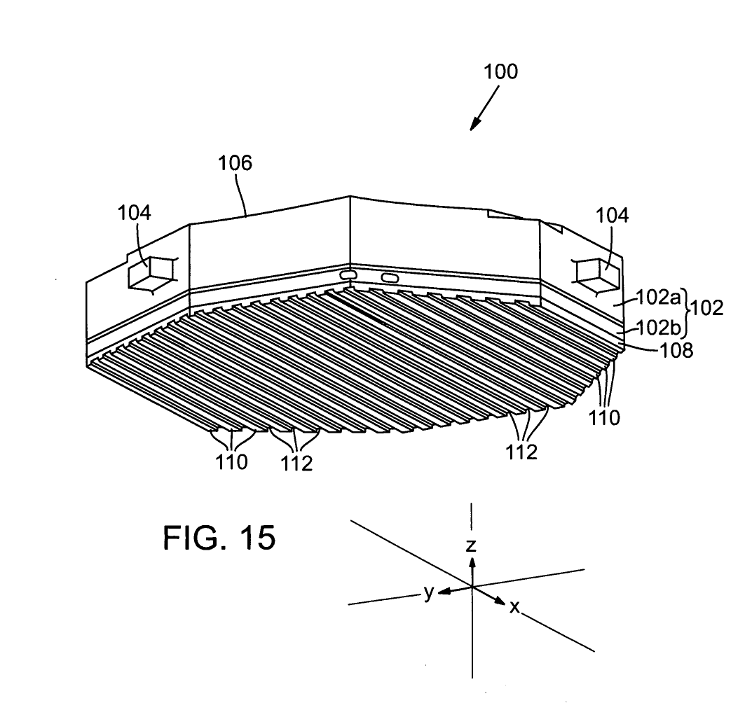

A mirror 100 according to this embodiment is shown in FIG. 15. The mirror 100 comprises a body 102 including a first body portion 102a, and a second body portion 102b. The first body portion 102a includes mounting ears 104 (two are shown; a third mounting ear is hidden beyond the far edge). Desirably, the mirror 100 is kinematically mounted by its mounting ears 104 to a base (not shown). The mirror 100 includes a reflective surface 106 facing upward in the figure. The mirror 100 also includes a correcting plate 108 bonded to the downward-facing surface. The correcting plate 108 comprises a regular array of ribs 110 and channels 112 (actually, the channels 112 in this embodiment are simply thinner regions between the ribs 110). The ribs 110 and channels 112 in this embodiment extend longitudinally in the X-direction. The longitudinal direction of the ribs 110 in FIG. 15 corresponds to the direction of the line L (FIG. 14(B)) that extends in the X-direction and connects the lowest points of the “saddle.”

In the ribbed structure of FIG. 15, the channels 112 or other gaps between the ribs 110 act as “expansion joints” that limit expansion in the direction normal to their longitudinal direction. In FIG. 16, the schematically depicted ribs 110 and channels 112 extend longitudinally in the X-direction. Expansion is denoted by the dotted lines 116. More expansion is realized in the X-direction (arrows 118) than in the Y-direction (arrows 120) as denoted by the relative lengths of the arrows 118, 120. Thus, relatively more expansion occurs in Y-direction, in the figure, which is normal to the longitudinal direction of the ribs 110. In other words, more bimetallic-like effect is realized in the X-direction than in the Y-direction. In fact, in the depicted embodiment, expansion in the X-direction (longitudinal direction of the ribs) is not significantly limited by the ribs 110. But, since the bimetallic-like effect is realized in both directions X and Y (although different in magnitude), relative expansion in the two orthogonal directions (X and Y) achieves both defocus and astigma compensations. In this embodiment, the thickness of the correcting plate is constant along any line parallel to the X-direction, and is regularly variable along any line parallel to the Y-direction.

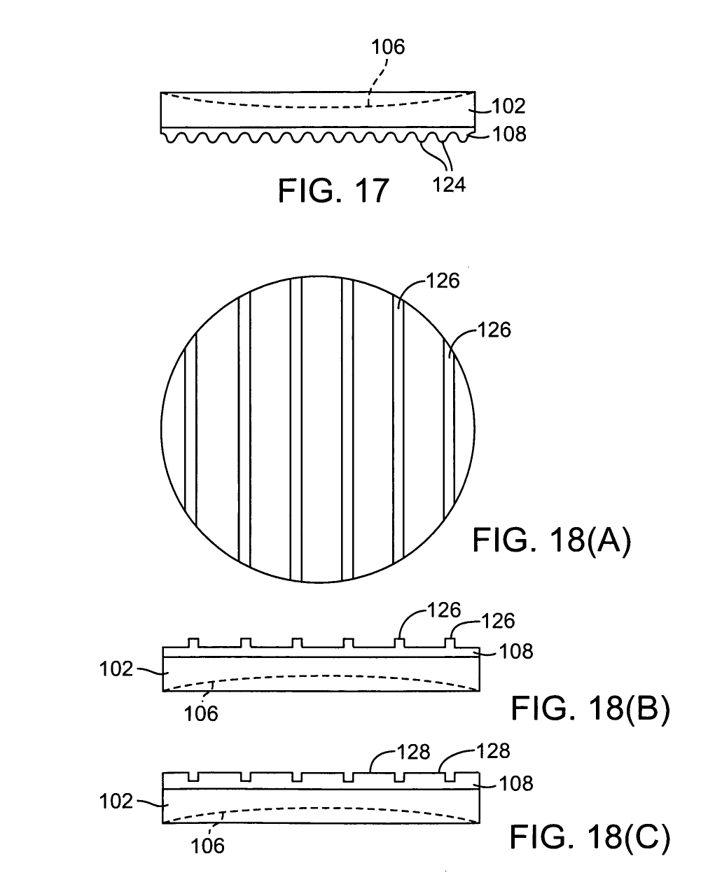

Although the FIG. 15 embodiment depicts the ribs and valleys having rectilinear transverse (sectional) profiles (e.g., when viewed in the X-direction), it will be understood that the transverse profiles can be other than rectilinear, such as (but not limited to) the serpentine-profiled ribs 124 shown in FIG. 17.

Furthermore, although the ribs shown in FIG. 15 are linear, it is contemplated that rib configurations other than linear may be useful for certain applications.

### Fifth Representative Embodiment

The pitch of the ribs 110 in the fourth representative embodiment (FIG. 15) is exemplary only and is not intended to be limiting. The ribs can be narrower or wider than shown in FIG. 15. For example, in the instant embodiment shown in FIGS. 18(A)-18(B), the ribs 126 are widely spaced apart. In the alternative configuration shown in FIG. 18(C), the ribs 128 are wide compared to the spaces between them.

### Sixth Representative Embodiment

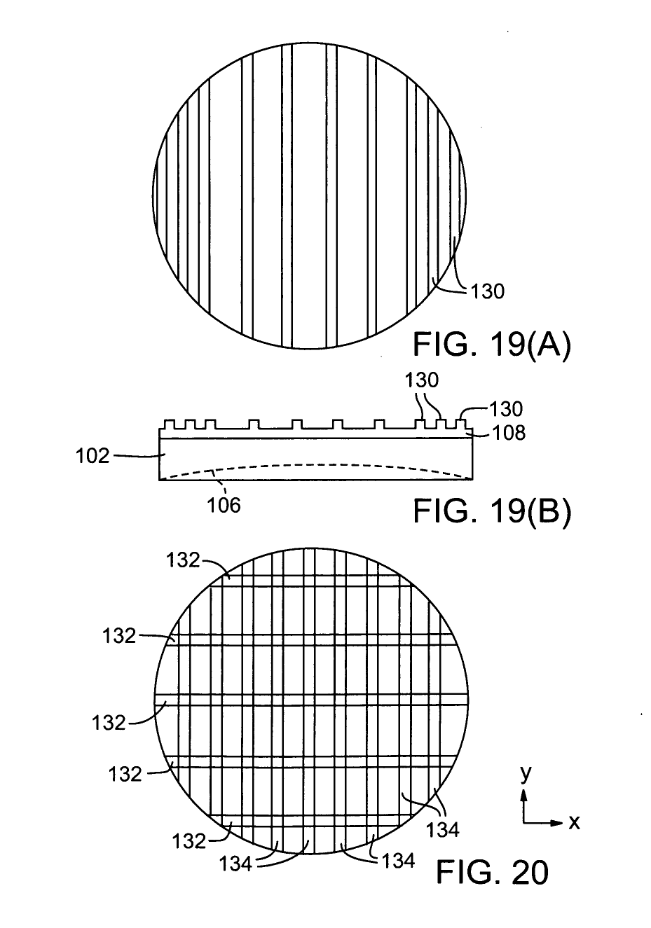

The pitch of the ribs or analogous structures need not be constant across the mirror. The instant embodiment, shown in FIGS. 19(A)-19(B), is one in which the pitch of the ribs 130 is variable.

An alternative embodiment is shown in FIG. 20, in which ribs 132, 134 extend in both the X- and Y-directions, but at different pitches. The respective rib pitches are constant, but the pitch in the X-direction is lower than in the Y-direction.

Although FIG. 20 depicts the ribs 132, 134 intersecting each other at right angles, it is possible for some applications that the ribs intersect each other at angles other than 90°.

Mirrors as described above have especial application in any of various optical systems that are specified to operate according to extremely tight tolerances of imaging performance. An example of such an optical system is a projection-optical system as used in microlithographic exposure systems utilizing EUV light as exposure light. EUV optical systems are reflective because of the current unavailability of materials suitable for fabricating EUV lenses. The principles of the invention alternatively can be applied to projection-optical systems and other optical systems of exposure apparatus using light of other wavelengths, rather than EUV light, as exposure light.

### Microlithography System Embodiment

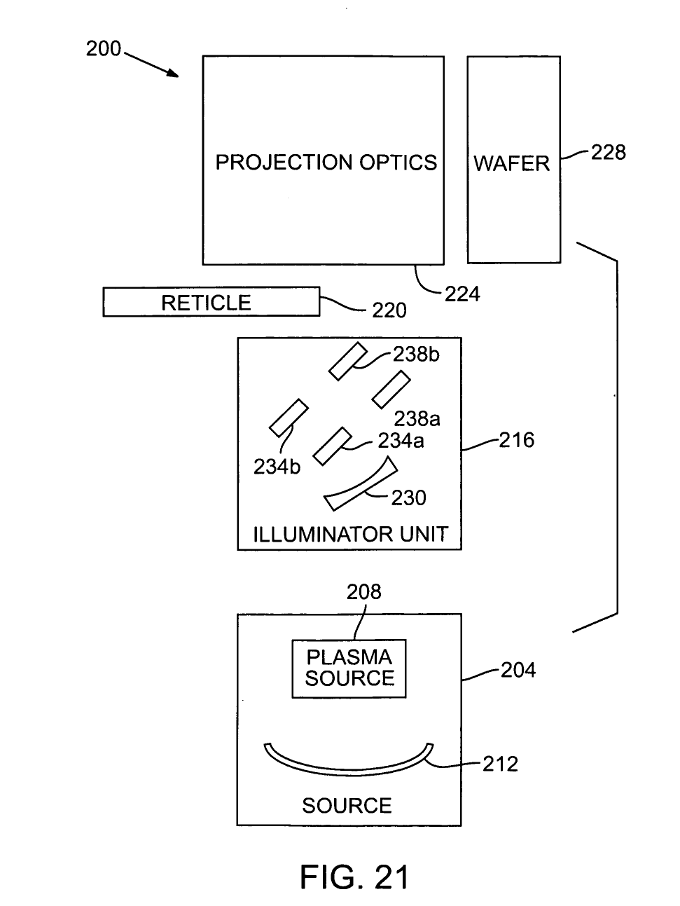

An embodiment of an EUV microlithography system 200 is shown in FIG. 21. The system 200 includes at least one mirror as described above. The system 200 includes a source 204, an illumination-optical system 216, a reticle 220, and projection-optical system 224, and is configured to imprint a pattern on a wafer 228 or other suitable lithographic substrate. The reticle 220 may generally be supported on a reticle-positioning stage, and the wafer 228 may generally be supported on a wafer-positioning stage. For ease of illustration, the reticle stage and wafer stage are not shown.

The source 204 generally includes a plasma source 208 and a collector mirror 212. The plasma source 208 may use a gas such as xenon as a laser-plasma target material. The plasma source 208 emits light that is collected by the collector mirror 212 and passed to the illumination-optical system 216. Light that is processed by the illumination-optical system 216 is reflected from the reticle 220 and passed through the projection-optical system 224 onto the wafer 228.

The illumination-optical system 216 includes a collimator mirror 230, multiple fly-eye mirrors 234a, 234b, and multiple condenser mirrors 238a, 238b. In general, the illumination-optical system 216 is situated and configured to condition the light emitted by the source 204 to improve the uniformity of the light. Light from the source 204 is partially absorbed by the collimator mirror 230 before being reflected onto the fly-eye mirrors 234a, 234b and condenser mirrors 238a, 238b. The fly-eye mirrors 234a, 234b generally have relatively complex-shaped reflective surfaces constructed of many concave mirror elements. The fly-eye mirror 234a receives light reflected from the collimator mirror 230 and reflects the light to the condenser mirror 238a. In turn, the condenser mirror 238a reflects light to the fly-eye mirror 234b, which reflects the light to the condenser mirror 238b.

Although substantially all the mirrors associated with the illumination-optical system 216 may be internally cooled using coolant fluid, some mirrors may be cooled using radiant methods. Typically, the collimator mirror 230 reflects approximately seventy percent of incident light. Hence, approximately thirty percent of incident light is absorbed by the collimator mirror 230. This thirty percent of absorbed radiation (e.g., approximately 90 Watts of energy in one embodiment) is difficult to remove from the mirror using radiant methods. Hence, the collimator mirror 230 is internally cooled, desirably with liquid coolant flowing through the mirror under laminar-flow or other non-turbulent flow conditions to minimize any temperature rise associated with the absorption of heat while also substantially minimizing vibration. This mirror 230 also desirably includes a correcting portion as described above.

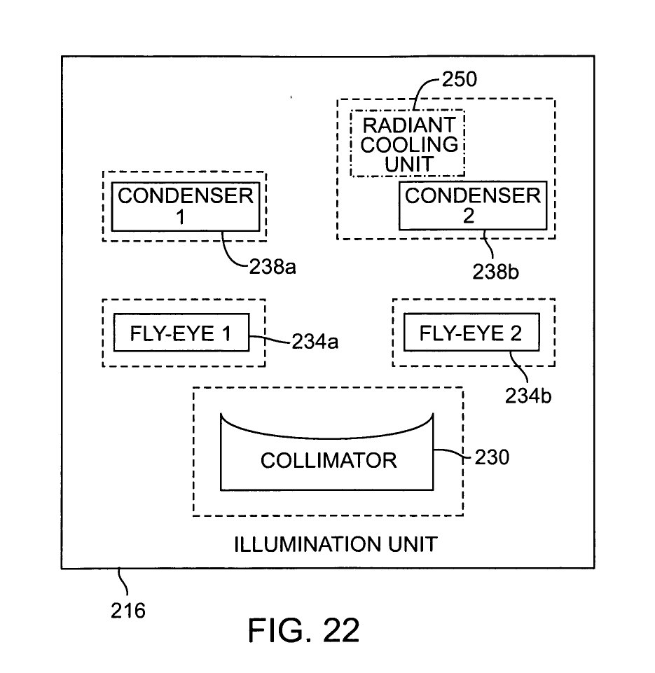

The mirrors of the illumination unit 216 may be cooled a variety of ways, depending upon the mirror. FIG. 22 is a diagrammatic representation of the illumination-optical system 216 comprising mirrors that are differently cooled. For example, the collimator mirror 230 is internally cooled using a coolant fluid under laminar-flow conditions. The fly-eye mirrors 234a, 234b are also internally cooled, generally under turbulent-flow conditions. The condenser mirror 238b is also cooled, either radiantly or by internal cooling. Radiant cooling (e.g., using a radiant cooling unit 250) is advantageous with this mirror because it works and this method is less complex and less expensive than internal cooling. Also, radiant cooling may be adequate for the heat-load associated with the condenser mirror 238b.

Any of the internally cooled mirrors and any of the radiantly cooled mirrors in the system embodiment described above can be configured as generally described herein. Each such mirror has a “bimetallic-like” property (used in a figurative sense and not necessarily denoting that the mirror is made of two metals, rather denoting that the mirror is made of at least two materials that collectively behave in a bimetallic manner to correct curvature changes accompanying mirror heating from radiation absorption). I.e., in many embodiments, as the temperature of the mirror increases, the bimetallic-like effect of the two materials introduces a countervailing (typically concave) deformation in the mirror. The concave deformation reduces the curvature radius of the reflective surface of the mirror, which is used to cancel the natural increase in the radius of curvature, as described above.

Notably, with an internally cooled mirror, the curvature of the mirror under no heat load can be tuned by minor adjustment from ambient of the temperature of the coolant entering the conduits in the mirror. If this coolant inlet temperature is maintained and the mirror configuration is properly tuned for no change in curvature, then it will work for any input illumination power.

Mirrors, as disclosed herein, having self-correcting curvature under conditions of heat load, provide generally improved performance of the optical system of which the mirrors are a part. Mirrors configured in this manner also allow the use of more common mirror materials, yielding more options and lower costs.

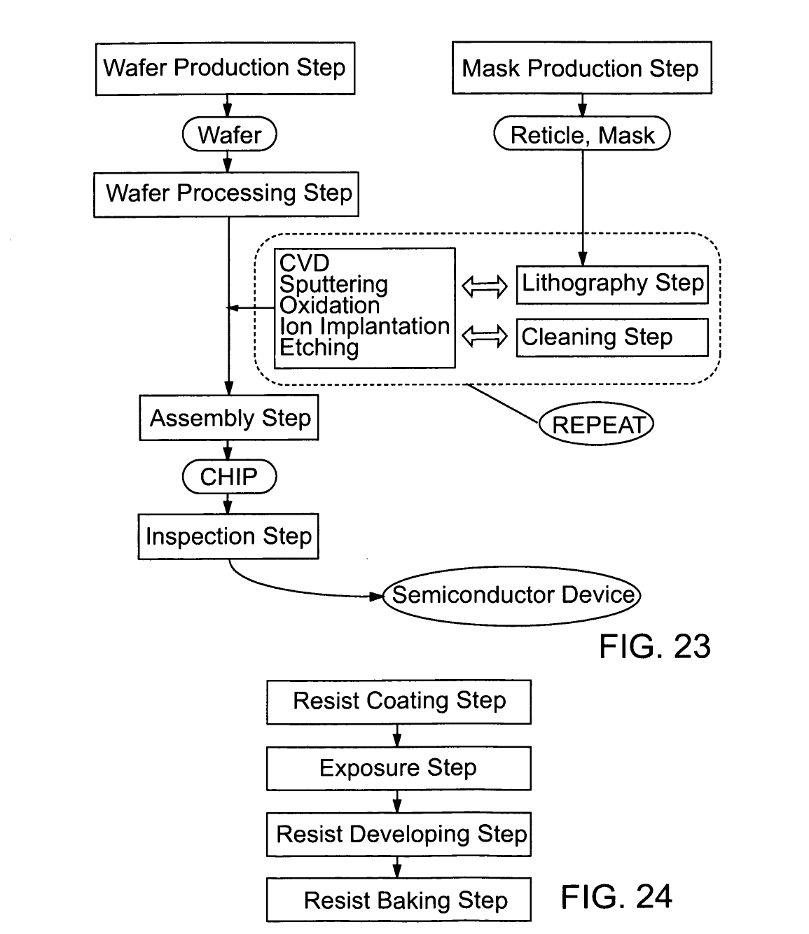

FIG. 23 is a flowchart of an exemplary microelectronic-fabrication method in which a lithographic projection-optical system including at least one mirror, as disclosed herein, can be applied readily. The fabrication method generally comprises the main steps of wafer production (wafer manufacturing or preparation), reticle (mask) production or preparation; wafer processing, device (chip) assembly (including dicing of chips and rendering the chips operational), and device (chip) inspection. Each step usually comprises several sub-steps.

Among the main steps, wafer processing is key to achieving the smallest feature sizes (critical dimensions) and best inter-layer registration. In the wafer-processing step, multiple circuit patterns are layered successively atop one another on the wafer, forming multiple chips destined to be memory chips or main processing units (MPUs), for example. The formation of each layer typically involves multiple sub-steps. Usually, many operative microelectronic devices are produced on each wafer.

Typical wafer-processing steps include: (1) thin-film formation (by, e.g., sputtering or CVD) involving formation of a dielectric layer for electrical insulation or a metal layer for connecting wires or electrodes; (2) oxidation step to oxidize the substrate or the thin-film layer previously formed; (3) microlithography to form a resist pattern for selective processing of the thin film or the substrate itself; (4) etching or analogous step (e.g., dry-etching) to etch the thin film or substrate according to the resist pattern; (5) doping as required to implant ions or impurities into the thin film or substrate according to the resist pattern; (6) resist stripping to remove the remaining resist from the wafer; and (7) wafer inspection. Wafer processing is repeated as required (typically many times) to fabricate the desired microelectronic devices on the wafer.

FIG. 24 provides a flowchart of typical steps performed in microlithography, which is a principal step in the wafer-processing step shown in FIG. 23. The microlithography step typically includes: (1) resist-application step, wherein a suitable resist is coated on the wafer substrate (which an include a circuit element formed in a previous wafer-processing step); (2) exposure step, to expose the resist with the desired pattern by microlithography; (3) development step, to develop the exposed resist to produce the imprinted image; and (4) optional resist-baking step, to enhance the durability of and stabilize the resist pattern.

The process steps summarized above are all well known and are not described further herein.

Whereas the invention has been described in connection with representative embodiments, it will be understood that the invention is not limited to those embodiments. On the contrary, the invention is intended to encompass all modifications, alternatives, and equivalents as may be included in the spirit and scope of the invention, as defined by the appended claims.

What is claimed is:

1. An optical element, comprising:
a first portion having a first coefficient of thermal expansion (CTE), an obverse surface, and a reverse surface; and
a second portion bonded to the reverse surface, the second portion having a second CTE different from the first CTE to form an optical element exhibiting a thermally multimetallic-like change in curvature of the obverse surface accompanying a temperature change of the optical element, the second portion having a thermal-response property in a first direction that is different from a thermal-response property in a second direction.

2. The optical element of claim 1, wherein the thermal-response properties are respective thickness profiles of the second portion in the first and second directions.

3. The optical element of claim 2, wherein at least one of the thickness profiles is of ribs and valleys.

4. The optical element of claim 1, wherein the thermal-response properties are respective CTEs of the second portion in the first and second directions.

5. The optical element of claim 1, wherein the obverse surface is a reflective optical surface.

6. The optical element of claim 1, wherein the first portion comprises multiple layers.

7. The optical element of claim 1, wherein the second portion comprises multiple layers.

8. The optical element of claim 1, wherein the first and second directions are normal to each other.

9. The optical element of claim 1, wherein the second portion has a thickness profile in the first direction that is different from a thickness profile in the second direction.

10. The optical element of claim 1, wherein:
the thickness profile in the first direction is linear; and
the thickness profile in the second direction is variable.

11. The optical element of claim 10, wherein:
the thickness profile in the first direction is substantially constant; and
the thickness profile in the second direction is periodic.

12. The optical element of claim 1, wherein:
the thickness profile in the first direction comprises ribs and valleys; and
the thickness profile in the second direction extends longitudinally along a rib or valley.

13. The optical element of claim 1, wherein:
the thickness profile in the first direction comprises ribs and valleys at a first pitch; and
the thickness profile in the second direction comprises ribs and valleys at a second pitch.

14. The optical element of claim 1, wherein the second portion has a CTE profile in the first direction that is different from a CTE profile in the second direction.

15. The optical element of claim 1, wherein the first and second portions have bimetallic-like structures providing the multimetallic-like change.

16. An optical element, comprising:
a first portion having an obverse optical surface and a reverse surface; and
a second portion bonded to the reverse surface, the second portion comprising multiple layers having respective coefficients of thermal expansion (CTEs) and being bonded together in a thermally multimetallic manner that, during heating of the optical element, provides the second portion with a bending moment that at least partially offsets a change in curvature of the optical surface resulting from the heating.

17. The optical element of claim 16, wherein the second portion comprises multiple layers bonded together in a thermally bimetallic manner.

18. The optical element of claim 17, wherein the multiple layers of the second portion have different respective thicknesses.

19. The optical element of claim 17, wherein:
the multiple layers of the second portion comprise a first layer bonded to the reverse surface of the first portion and a second layer bonded to the first layer; and
the first layer has a lower CTE than the second layer.

20. The optical element of claim 16, wherein at least one of the layers of the second portion has a variable thickness.

21. The optical element of claim 16, wherein the second portion is internally cooled.

22. The optical element of claim 16, wherein at least one layer of the second portion is tuned according to a variable property of the first portion.

23. The optical element of claim 35, wherein the variable property is thickness or CTE.

24. A method for correcting radiation-induced thermal deformation of a reflective optical element having a respective coefficient of thermal expansion (CTE), a reflective surface arranged to receive radiation, and a reverse surface, the method comprising:
providing on the reverse surface a correcting portion having a respective CTE that is different from the CTE of the optical element sufficiently to cause differential thermal expansion, in a thermally multimetallic manner, of the correcting portion relative to the optical element;
providing the correcting portion with a thermal-response property in a first direction that is different from a thermal-response property in a second direction; and
as radiation is received by the optical element and heats the reflective surface, allowing the correcting portion to impart a bending moment to the optical element that at least partially offsets a thermal deformation of the reflective surface resulting from the heating.

25. A method for correcting radiation-induced thermal deformation of a reflective optical element having a respective coefficient of thermal expansion (CTE), a reflective surface arranged to receive radiation, and a reverse surface, the method comprising:
forming a correcting portion including at least two layers of respective materials having respective coefficients of thermal expansion (CTEs) that are sufficiently different to cause the correcting portion to exhibit a multimetallic-like bending moment when heated;
attaching the correcting portion to the reverse surface of the optical element; and
as radiation is received by the optical element and heats the reflective surface, allowing the correcting portion to apply its bending moment to the optical element that at least partially offsets a thermal deformation of the reflective surface resulting from the heating.
